(19) United States
(12) Patent Application Publication
(10) Pub. No.: US 2020/0403428 A1
(43) Pub. Date: Dec. 24, 2020

(54) BATTERY PACK AND BATTERY MANAGEMENT SYSTEM FOR USE THEREWITH

(71) Applicant: Harris Battery Company, Inc., Bolivar, OH (US)

(72) Inventors: Momodou Bah, Canton, OH (US); Sidney Geibel, Orrville, OH (US); John Levengood, Hartville, OH (US)

(73) Assignee: Harris Battery Company, Inc., Bolivar, OH (US)

(21) Appl. No.: 16/802,068

(22) Filed: Feb. 26, 2020

Related U.S. Application Data
(63) Continuation-in-part of application No. 16/444,113, filed on Jun. 18, 2019.

(51) Int. Cl. H02J 7/00; H01M 10/46; H01M 10/42; H01M 10/44; H01M 10/48

(52) U.S. Cl. CPC H02J 7/00047; H01M 2010/4278; H02J 7/0014; H02J 7/0049; H02J 7/00302; H02J 7/00306; H02J 7/00036; H02J 7/00712; H01M 10/46; H01M 10/425; H01M 10/441; H01M 10/482; H01M 10/4207; H01M 2010/4271; H02J 7/0013

(57) ABSTRACT

A portable battery pack containing multiple battery stacks operable to deliver power to equipment with differing power requirements that may further be compact and easily maintained. Further, the battery pack may have an integrated battery management system and charger system to prevent over-discharge and/or overcharging of the battery cells contained therein.

### CROSS REFERENCE TO OTHER APPLICATIONS

This application is a Continuation-In-Part of U.S. patent application Ser. No. 16/444,113 filed on Jun. 18, 2019. The entire disclosure of which is incorporated herein by reference.

### TECHNICAL FIELD

The present disclosure relates generally to the field of portable battery packs. More particularly, the present disclosure relates to a portable rechargeable battery pack capable of outputting power at multiple voltage ratings. Specifically, the present disclosure relates a portable and rechargeable battery pack with multiple output connections to allow power discharge with multiple voltage outputs and with a battery management system for controlling the charging and discharging thereof.

### BACKGROUND

### Background Information

Portable battery packs have a wide variety of application which is only expected to increase as the world moves towards more green technologies. One particular area where battery packs may be utilized is in the manufacture of small equipment and small industrial machines, such as forklifts, pallet jacks, skid loaders, and the like. Particularly, these types of machines may include electrical components, such as starters and onboard tools, and they may further be fully powered by electrical motors. Accordingly, in the manufacturing of such equipment, it is common that an assembled machine, for example a forklift, may need to be moved about the manufacturing floor during assembly, as well as moved to an area for storage when completed and prior to the sale, shipment, and/or delivery thereof.

When moving such equipment and apparatuses around the manufacturing floor and/or to a storage areas, it is often easier to provide power to a particular piece of equipment and move it under its own power than to use cranes or other such devices. This is further true when manufactured equipment undergoes testing or quality control. Despite this, it is disadvantageous to install permanent batteries into such equipment, as once the manufacturing and/or testing processes are completed, they may sit for a period of months or years until sold or otherwise delivered to a customer. In that time, batteries may degrade, thus causing a battery to “date out” before the equipment is delivered. Instead, may be beneficial to install a permanent battery into such equipment immediately prior to shipping to provide the end purchaser a battery with substantially all of its usable life remaining. Therefore, temporary batteries are often provided when moving equipment around the manufacturing floor and/or for testing situations.

Where temporary batteries are furnished as a supply of operational batteries, i.e. the same as what would be permanently included when delivering the apparatus, they must be installed and uninstalled each time a piece of equipment is moved and the battery is needed elsewhere. This can be time-consuming and difficult and often requires complete access to the battery compartment in the equipment, which may necessitate further tools and/or efforts to reach, depending on the location of the battery compartment. Further, as these temporary batteries are depleted and recharged through multiple discharge cycles, they lose effectiveness, requiring replacement at a frequent rate. A manufacturing facility using such a technique may then be required to stock and maintain a large or disproportionate number of these batteries which can be expensive and take up significant space in the facility for the storage thereof. Further, as different equipment may have different sizes, types, and/or optional accessories, each apparatus may require different batteries with different outputs. Thus, a manufacturing facility might be required to stock and maintain several different versions of such temporary batteries.

Alternatively, some manufacturers may utilize temporary batteries that are provided as a large battery banks. These battery banks can be substantial in size which can often make them cumbersome and may require additional equipment, such as a crane, an operating forklift, a pallet jack, or the like to move them about the manufacturing floor between assembly and testing stations. This can create a large moving hazard for workers, and the size may prevent the ability to maneuver through tight spaces. Further, when used to move an apparatus from one location to another, such as to storage or between assembly stops, it may typically require that a large battery bank be moved alongside each piece apparatus, thus increasing the time and space required. Further, while these battery banks tend to have a large power capacity, they also tend to take significant time to recharge, Thus, multiple battery banks may be needed for normal operations, and given their size, may represent a significant cost to the manufacturer while also requiring a large storage area. In areas of limited space, or for manufacturers with a limited budget, these large battery banks may not be a feasible solution. Additionally, a single manufacturer may produce different apparatuses with differing power requirements, which the use of battery banks may not fully address, thus requiring multiple battery banks.

### SUMMARY

The present disclosure addresses these and other issues by providing a portable battery pack capable of being transported by a single individual that contains a modular battery operable to deliver power to equipment with different voltage requirements that may further be compact and easily maintained. Further, the present disclosure may provide a battery pack having an onboard battery management system and charger system to prevent over-discharge and/or overcharging of the battery packs contained therein.

In one aspect, the present disclosure provides a battery pack comprising: a first plurality of individual battery cells arranged into a first battery stack having a first voltage rating in operative communication with a first output, the first output having the same voltage rating as the first battery stack; a second plurality of individual battery cells arranged to a second battery stack having a second voltage rating in operative communication with a second output, the second output having the same voltage rating as the second battery stack; and a third plurality of individual battery cells arranged into a third battery stack having a third voltage rating in operative communication with a third output, the third output having the same voltage rating as the third battery stack; a battery management system wherein the battery management system is able to recognize or be programmed to recognize battery type of the battery cells within each of the first battery stack, the second battery stack and the third battery stack; and a charger in operative communication with, and operable to recharge, each of the first, second, and third battery stacks. This embodiment or another embodiment provide the first plurality of individual battery cells, the second plurality of individual battery cells and the third plurality of individual battery cells comprise at least one of the following types of battery cells: NiCd, NIMH, Lead Acid, LCO, LMO, NMC, LFP, NCA and LTO. This embodiment or another embodiment provide the first battery stack is rated to deliver 24 volts through the first output. This embodiment or another embodiment provide the first and second battery stacks are rated to deliver 36 volts through the second output. This embodiment or another embodiment provide the first, second, and third battery stacks are rated to deliver 48 volts through the third output. This embodiment or another embodiment provide the battery management system further comprises a charging system operable to direct the charger to recharge the first, second, and third battery stacks. This embodiment or another embodiment provide a communications port in operable communication with the battery management system and further operable to communicate battery data to an external device and battery data to the battery management system. This embodiment or another embodiment provide the communications port further comprises: a wireless transceiver operable to wirelessly transmit battery data to the external device. This embodiment or another embodiment provide a display unit operable to display at least one of the capacity, charge level, ambient temperature, operating time, battery type, and voltage of the battery pack.

In another aspect, the present disclosure provides a method of discharging a battery pack comprising: receiving a connection to an apparatus in one of a first output, a second output, and a third output of a battery pack; providing a first battery stack, a second battery stack and a third battery stack; adjusting the battery pack in response to at least one identifying indicia on the battery stack corresponding to a battery type; and discharging power from at least one of: the first battery stack in response to receiving the connection in the first output; the first battery stack and the second battery stack in response to receiving the connection in the second output; and the first battery stack, the second battery stack, and the third battery stack in response to receiving the connection in the third output. This embodiment or another embodiment provide the first battery stack, the second battery stack, and the third battery stack comprise battery cells of at least one of the following types of battery cells: NiCd, NiMH, Lead Acid, LCO, LMO, NMC, LFP, NCA and LTO. This embodiment or another embodiment provide the first battery stack is rated at 24 volts and the method further comprises: discharging 24 volts of power from the first battery stack through the first output in response to receiving the connection in the first output. This embodiment or another embodiment provide wherein the second battery stack is rated at 12 volts and the method further comprises: discharging 36 volts of power from the first battery stack and the second battery stack through the second output in response to receiving the connection in the second output. This embodiment or another embodiment provide the third battery stack is rated at 12 volts and the method further comprises: discharging 48 volts of power from the first battery stack, the second battery stack, and the third battery stack through the third output in response to receiving the connection in the third output. This embodiment or another embodiment provide the battery pack includes a battery management system and the method further comprises: monitoring the charge level of the first battery stack, the second battery stack, and the third battery stack via the battery management system; and interrupting the discharge of the first battery stack, the second battery stack, and the third battery stack via the battery management system when the charge level falls below a preset threshold.

In yet another embodiment, the present disclosure provides a method of charging a battery pack comprising: receiving a connection to an external power source by a plug on a battery pack; providing a first battery stack, a second battery stack and a third battery stack; adjusting the battery pack in response to at least one identifying indicia on the battery stack corresponding to a battery type; and delivering power through a charger carried in the battery pack to one or more of the first battery stack, the second battery stack, and the third battery stack, according to the relative power levels thereof such that power is first delivered to the battery stack with the lowest charge level before delivering power to battery stacks with higher charge levels and wherein the first battery stack, second battery stack and third battery stack have the same battery cell types. This embodiment or another embodiment provide the first battery stack, the second battery stack, and the third battery stack comprise battery cells of at least one of the following types of battery cells: NiCd, NiMH, Lead Acid, LCO, LMO, NMC, LFP, NCA and LTO. This embodiment or another embodiment provide delivering power to the battery stack with the lowest relative charge level to raise the battery stack to a charge level equal to a charge level of the battery stack with the second highest charge level; delivering power to the both of the equal battery stacks simultaneously to raise the charge levels thereof to a charge level equal to the charge level of the battery stack with the highest charge level; and delivering power to all three of the first, second, and third battery stacks simultaneously to raise the charge levels thereof to a full capacity charge level. This embodiment or another embodiment provide the battery pack includes a battery management system and the method further comprises: monitoring the charge level of the first battery stack, the second battery stack, and the third battery stack via the battery management system; directing the delivery of power between the first, second, and third battery stacks according to the relative charge levels thereof; and interrupting the delivery of power to the first, second, and third battery stacks when the charge levels thereof reach the full capacity charge level. This embodiment or another embodiment provide directing the delivery of power to all three of the first, second, and third battery stacks regardless of their relative charge levels only when the battery management system determines that the charge levels of are three battery stacks are below a minimum threshold; charging each of the first, second, and third battery stacks nearly simultaneously to the full capacity charge level; and interrupting the delivery of power to the first, second, and third battery stacks individually when the charge levels of each stack reaches the full capacity charge level.

### BRIEF DESCRIPTION OF THE SEVERAL VIEWS OF THE DRAWINGS

A sample embodiment of the disclosure is set forth in the following description, is shown in the drawings and is particularly and distinctly pointed out and set forth in the appended claims. The accompanying drawings, which are fully incorporated herein and constitute a part of the specification, illustrate various examples, methods, and other example embodiments of various aspects of the disclosure. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 is a front right isometric view of a battery pack housing according to one aspect of the present disclosure.

FIG. 2 is a right side elevation view of a battery pack housing according to one aspect of the present disclosure with a left side view thereof being a mirror image of FIG. 2.

FIG. 3 is a rear elevation view of a battery pack housing according to one aspect of the present disclosure.

FIG. 4 is an exploded front right isometric view of a battery pack housing according to one aspect of the present disclosure.

FIG. 5 is a top plan view of a battery pack and battery pack housing according to one aspect of the present disclosure.

FIG. 6 is a front elevation view of a battery pack and battery pack housing with a front panel thereof removed according to one aspect of the present disclosure.

FIG. 7 is a front right isometric view of a battery pack with various components removed and the housing thereof rendered in dashed lines for clarity according to one aspect of the present disclosure.

FIG. 8 is a front right isometric view of a battery pack with various components removed and the housing thereof rendered in dashed lines for clarity according to one aspect of the present disclosure.

FIG. 9 is a front right isometric view of a battery pack with various components removed and the housing thereof rendered in dashed lines for clarity according to one aspect of the present disclosure.

FIG. 10 is a rear left isometric view of a battery pack with various components removed and the housing thereof rendered in dashed lines for clarity according to one aspect of the present disclosure.

FIG. 11 is a wiring diagram for a battery pack according to one aspect of the present disclosure.

FIG. 12 is a left side elevation operational view of a battery pack installed on a forklift according to one aspect of the present disclosure.

FIG. 13 is a front elevation operational view of a battery pack according to one aspect of the present disclosure.

Similar numbers refer to similar parts throughout the drawings.

### DETAILED DESCRIPTION

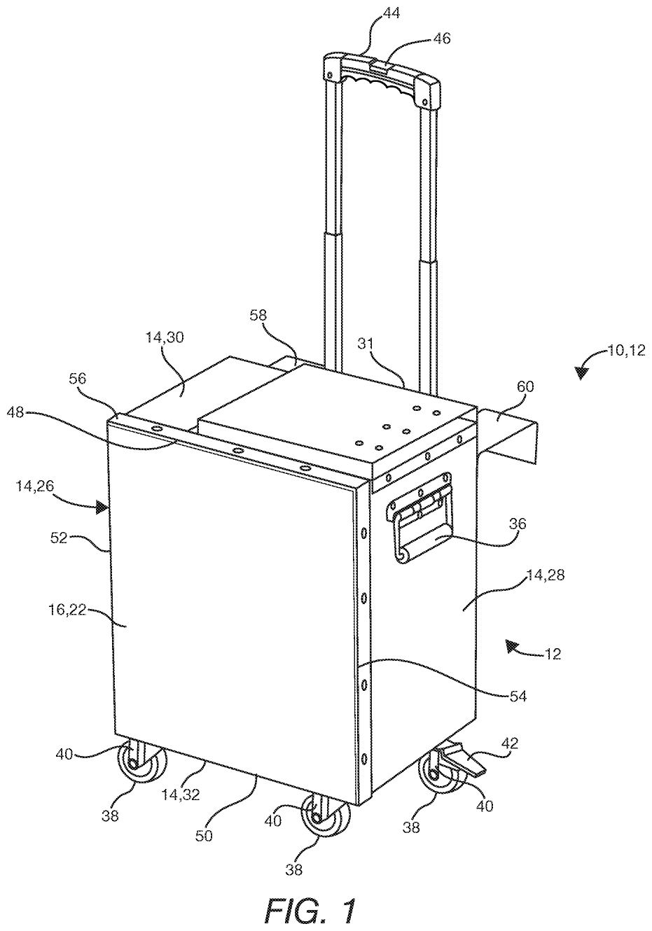

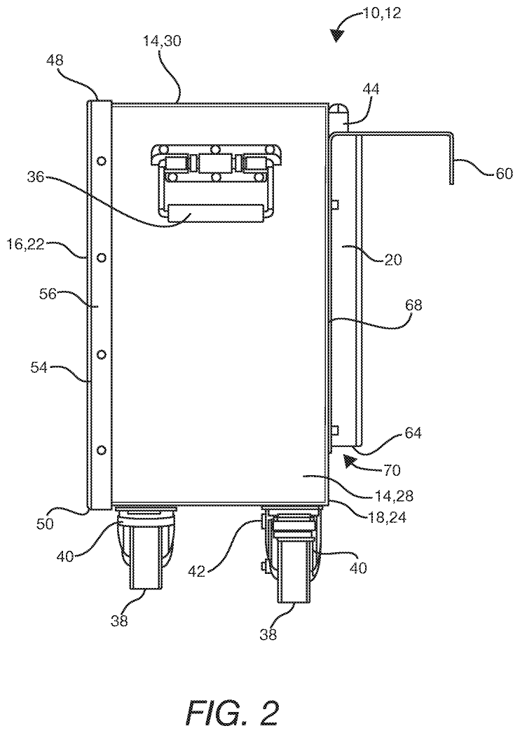

With reference to FIGS. 1-5, a portable battery pack 10 may include a housing 12 which may have a body 14, a front panel 16, a rear panel 18, and a mounting bracket 20. Housing 12 may further serve as a case for internal battery pack 10 components which will be discussed further below.

Body 14 of housing 12 may have a front side 22 which may be spaced apart from a rear side 24 and may define a transverse direction therebetween. Front side 22 may further engage front panel 16 as discussed herein, while rear side 24 may further engage or otherwise be rear panel 18 as discussed further herein. Body 14 may further have a left side 26 spaced apart from a right side 28 and defining therebetween a longitudinal direction. Body 14 may have a top 30 spaced apart from a bottom 32 and defining therebetween a vertical direction. Top 30 may additionally have or include a protective cover 31 (as seen in FIG. 1 and intentionally omitted from the remaining figures for purposes of clarity) to shield various exterior components (e.g. outputs 80, 82, and/or 84—discussed below) of battery pack 10 from damage. Cover 31 may be separable from top 30 and may be connected thereto by any suitable connectors including, but not limited to, screws, clips, bolts, magnets, adhesives, or the like. Each of the front side 22, rear side 24, left side 26, right side 28, top 30, and bottom 32 may collectively give housing 12 a generally rectangular shape and may form or define an interior 34 of body 14 in which may be disposed interior battery pack 10 components as discussed further herein.

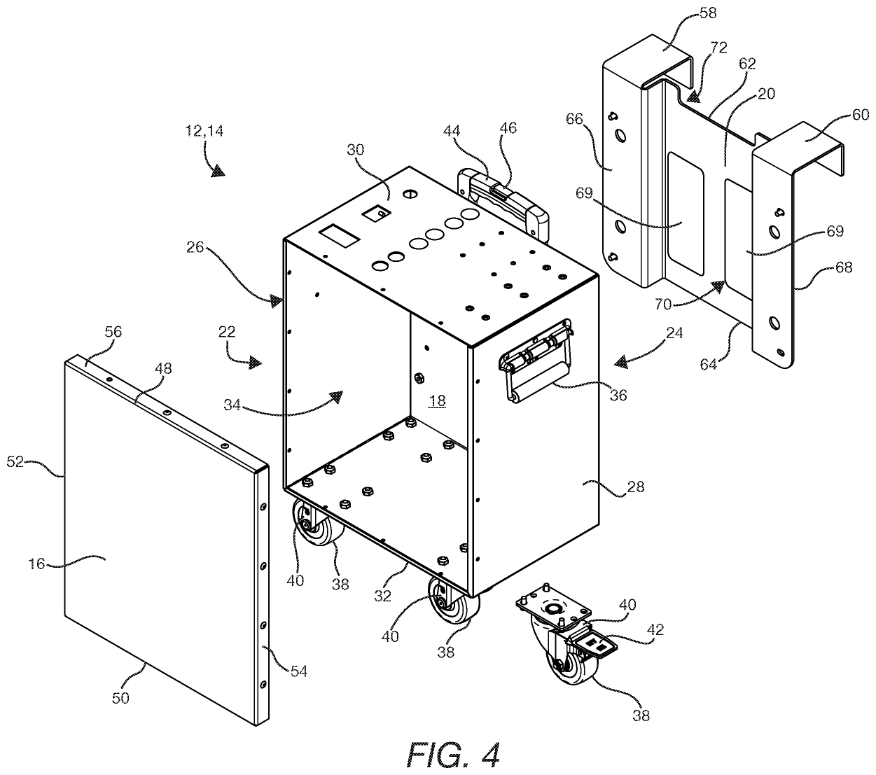

Body 14 of housing 12 may further include a series of holes or apertures to facilitate mounting or attachment of additional components thereto as discussed below. These holes may be best illustrated in FIG. 4 and have been omitted from the remaining figures for clarity. The location, shape, size, and number of holes provided in body 14 may vary depending upon the desired implementation of the disclosure herein, thus it will be understood that the holes illustrated in the figures are representative examples and not limiting illustrations thereof. Holes or other such apertures may additionally be formed in the body for purposes of ventilation and/or heat exchange between battery pack 10 and the ambient environment.

Left side 26 and right side 28 of body 14 may include handles 36 which may be affixed to the left and right sides 26, 28 of body 14 and may further permit battery pack 10 to be lifted or otherwise carried by a user thereof. Body 14 may further include one or more wheels 38 and casters 40 to further facilitate movement of battery pack 10 as desired. Casters 40 and wheels 38 may be installed on body 14 through the use of bolts, screws, rivets, or the like to affix casters 40 to bottom 32 of body 14 as best seen in FIG. 1. Casters 40 and wheels 38 may further include one or more braking mechanisms or brakes 42 to lock one or more of the wheels 38 in position to prevent unwanted movement of battery pack 10 as desired.

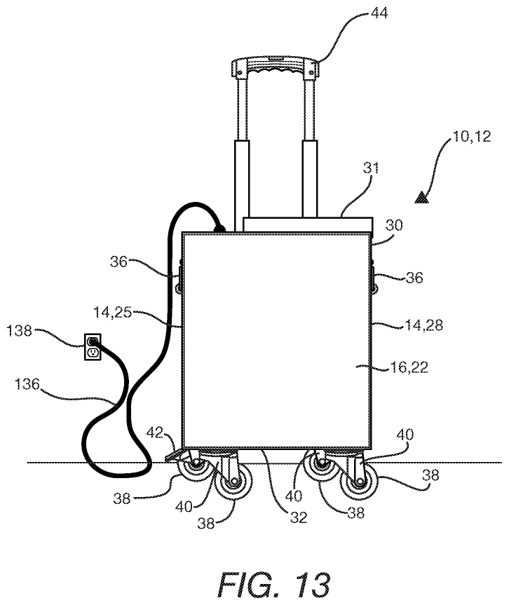

Body 14 of housing 12 may further include an extendable handle 44 which may be bolted, screwed, riveted, welded, or otherwise fixedly attached to rear side 24 and/or rear panel 18 of housing 12. Extendable handle 44 may include a latching mechanism 46 which may allow handle 44 to lock in the extended position as shown in FIGS. 1 and 13, or in a closed position as seen in the remaining figures. Extendable handle 44 may be similar to telescoping luggage handles as found on a standard suitcase or the like and may further facilitate movement of the portable battery pack 10 as discussed further below.

Front panel 16 of housing 12 may have a top edge 48 spaced apart from a bottom edge 50 in the vertical direction. Front panel 16 may further have a left side edge 52 spaced apart from a right side edge 54 in a longitudinal direction. Each of the top edge 48, bottom edge 50, left side edge 52, and right side edge 54 may correspond to the top 30, bottom 32, left side 26, and right side 28 of body 14 and may allow placement of front panel 16 on front side 22 of body 14. Front panel 16 may further include a flange 56 that extends rearward from each edge 48, 50, 52, and 54 of front panel 16 and may allow front panel 16 to be mounted to body 14 through the use of screws, bolts, clips, rivets, or other such connectors. According to one aspect, front panel 16 may be mounted through any means, including mechanical, chemical, or non-mechanical or non-chemical connectors. According to another aspect, front panel 16 may be mounted to body 14 through magnets, adhesive, or the like. It will be understood that front panel 16 may be removable from body 14 to allow access to the interior 34 of body 14 to maintenance and repair purposes as needed.

Rear panel 18 may form the rear side 24 of body 14 and may be integral with body 14 in that it may be fixed or fixedly attached to body 14 of housing 12. According to another aspect, rear panel 18 may be removable similar to front panel 16 through an attachment means, such as bolts, screws, clips, magnets, or the like. According to another aspect, rear panel 18 may be separable from housing 12, but fixedly attached thereto by a more robust connection, such as welding, rivets, or the like.

Mounting bracket 20 may include a left mounting hook 58 and a right mounting hook 60 disposed at a top edge 62 thereof. The mounting bracket 20 may further have a bottom edge 64 spaced apart from the top edge 62 in a vertical direction and a left edge 66 spaced apart from a right edge 68 in a longitudinal direction. Each of the top edge 62, bottom edge 64, left edge 66, and right edge 68 may correspond to the top 30, bottom 32, left side 26, and right side 28 of body 14, respectively.

Mounting bracket 20 may further define a series of apertures for securing mounting bracket 20 to rear panel 18 of housing 12. According to one aspect, mounting bracket 20 may be removably secured to rear panel 18 through employment of screws, bolts, clips, or the like. It will be understood that the securing mechanism should provide sufficient strength to the connection of mounting bracket 20 to rear panel 18 to support the entire weight of battery pack 10 when left and right mounting hooks 58, 60 are employed as discussed further herein. According to another aspect, mounting bracket 20 may include one or more cutouts 69 defined therein that may allow for reduction of the overall weight of mounting bracket 20 and battery pack 10 without compromising the structural integrity thereof. According to another aspect, mounting bracket 20 may be fixedly secured to rear panel 18 through more robust connection, such as welding, rivets, or the like.

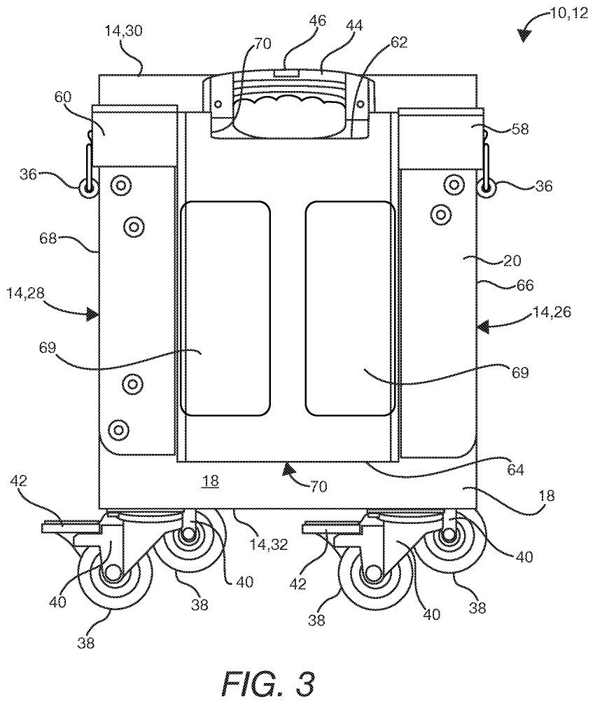

Mounting bracket 20 may further define a recessed portion, or recess, 70 which may allow mounting bracket 20 to be installed over retractable handle 44 on rear panel 18. As illustrated in the figures, it will be understood that recessed portion 70 may be sized and shaped appropriately to accept the main portion of retractable handle 44 therein to both conceal and protect retractable handle 44 from damage as portable battery pack 10 is used according to the methods and operation discussed further herein. The top edge 62 of mounting bracket 20 may further define a notch 72 which may allow user access to retractable handle 44 when the retractable handle 44 is in a stowed position, as best illustrated in FIG. 3. According to another aspect, retractable handle 44 may be external of mounting bracket 20. According to yet another aspect, mounting bracket 20 may be configured to fit over retractable handle 44 without a need for recess 70. It will be understood that various configurations of mounting bracket 20 and retractable handle 44 may be chosen according to the desired implementation.

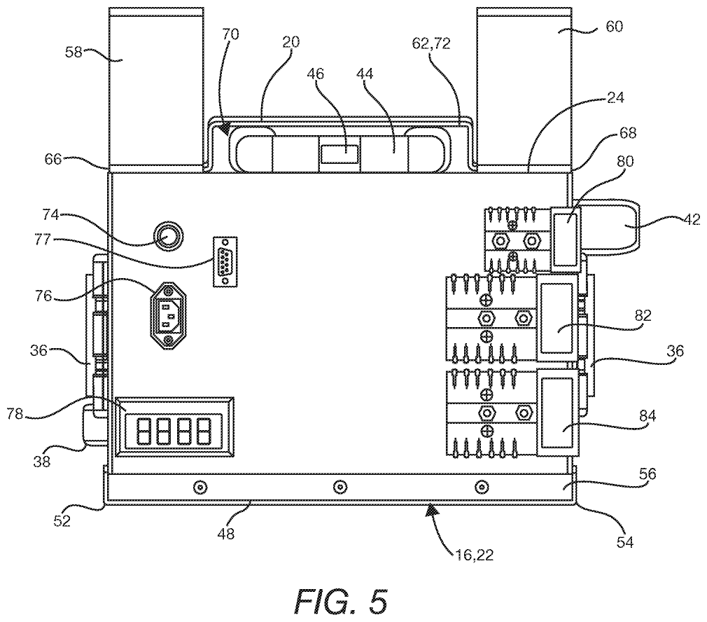

Left and right mounting hooks 58, 60 may extend rearwardly from mounting bracket 20 with a downward extending portion at the rearwardmost side thereof. As best seen in FIG. 5, the mounting hooks 58, 60 may then have a profile shape of an inverted J when viewed in conjunction with mounting bracket 20 such that hooks are contemplated to attach to the top side of a rail or other structure as discussed further herein. According to one aspect (not shown), left and right mounting hooks 58, 60 may be adjustable in height and/or depth to allow for adjustable mounting on surfaces of different shapes and sizes.

Each of front panel 16, rear panel 18, mounting bracket 20, and each face of body 14, including left side 26, right side 28, top 30, and bottom 32 may be manufactured out of durable material, such as steel, another sheet metal, or another suitable material. According to one aspect, body 14 may be formed out of a single continuous sheet of material which may be cut and folded to form the shape of body 14 with welds or other fasteners being applied at the joints of the folded faces. According to another aspect, each face of body 14 may be manufactured separately and assembled together using known manufacturing techniques and methods. Edges of each face of body 14, front panel 16, rear panel 18, and/or mounting bracket 20 may be rolled or curled to provide a smooth surface which may reduce cut injuries from sharp edges thereof. Front panel 16 and mounting bracket 20 each may likewise be formed from a single sheet of similarly durable material and folded into shape, or alternatively formed from separate pieces and assembled into the desired shape.

Each component of housing 12 may be painted or otherwise coated with a fire-resistant material to protect the contents thereof in case of a fire or overheating battery. According to another aspect, any such coatings or materials applied to housing 12 may further have anticorrosion properties to prevent accidents involving damage to the battery pack 10 contained therein. Further, each component of housing 12 may be coated or otherwise treated with shock-resistant material to prevent or reduce shock hazards.

When fully assembled, housing 12 may have a generally rectangular shape with an overall appearance generally resembling a rectangular case, such as a suitcase or wheeled briefcase; however, it will be understood that other shapes and configurations for housing 12 may be provided as dictated by the desired implementation of battery pack 10.

Portable battery pack 10 may further include two general types of components, namely, exterior components, defined as elements and pieces that are either mounted to the exterior of housing 12 and/or are exposed to the exterior of housing 12 when front panel 16 is installed on body 14, and interior components, which are elements of the battery pack 10 that are contained within the interior 34 of body 14.

With reference to FIG. 5, exterior components are shown and are generally situated about the top 30 of body 14. Exterior components may include a power switch 74, an alternating current (AC) plug 76, a communications port 77, readout 78, a 24 volt (24V) output 80, a 36 volt (36V) output 82, and a 48 volt (48V) output 84. Some or all of these exterior components may have portions that extend through apertures in top 30 of body 14, as discussed above. Further, some or all of these exterior components may be connected with interior components as discussed further herein. Although shown in specific locations on top 30 of body 14, it will be understood that exterior components of battery pack 10 may arranged in any order or position, and with any suitable orientation on body 14 according to the desired implementation. This may include various components that may be arranged on the sides 22, 24, 26, 28, top 30, and/or bottom 32 as desired.

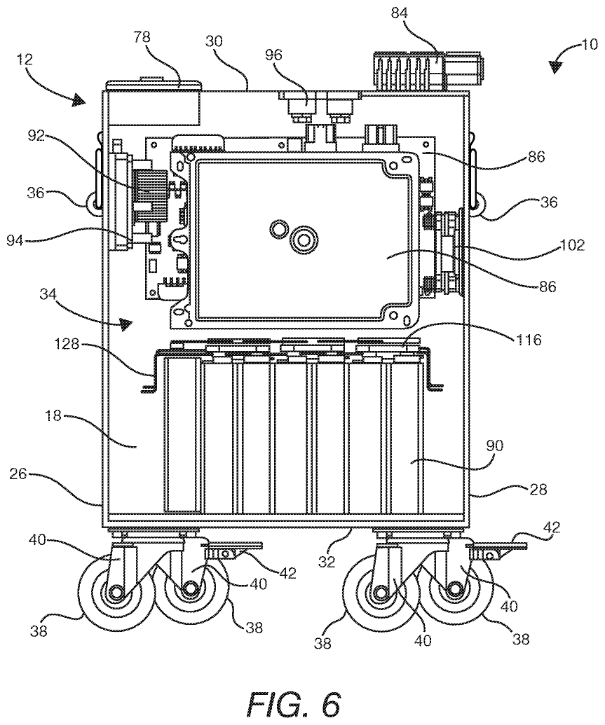

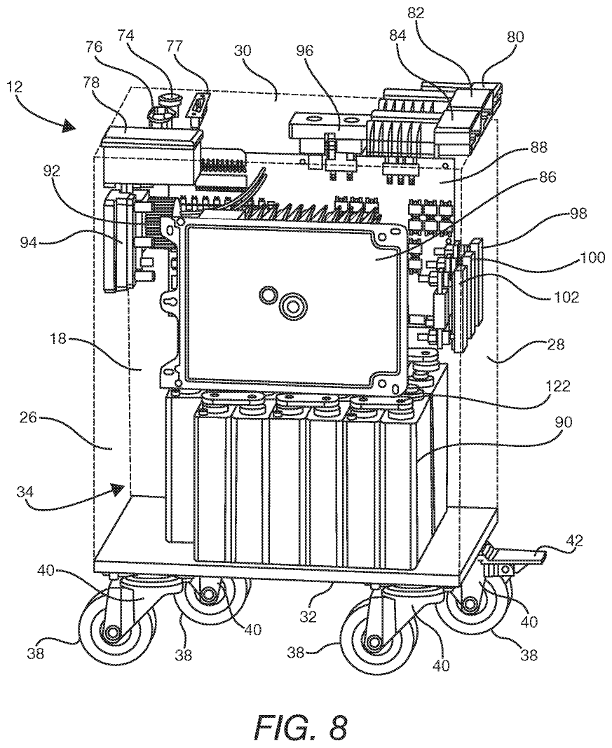

With reference to FIGS. 6-10, the interior components of battery pack 10, which may be contained within the interior 34 of housing 12 are shown and described. For each of FIGS. 6-10, various elements or components of battery pack 10 and/or housing 12 have been removed or rendered in dashed lines for the purposes of clarity. It will therefore be understood that these elements are present and removed only for clarity, unless specifically stated otherwise.

Accordingly, interior components of battery pack 10 may include a charger 86, a printed circuit board (PCB) 88, a plurality of battery cells 90, a contactor 92, a common ground 94, a shunt 96, a 24V fuse 98, a 36V fuse 100, and a 48V fuse 102. Interior compartment 34 may further include interior portions of exterior components such as the power switch 74, AC plug 76, readout 78, as well as the connections to the 24V output 80, 36V output 82, and 48V output 84.

Power switch 74 may be a toggle switch, button, or the like that is operable to switch battery pack 10 between an off condition wherein no power is delivered from the battery cells 90 through any of the 24V, 36V or 48V outputs 80, 82, 84 and an on position where power is delivered from battery cells 90 through one or more of the 24V, 36V, or 48V outputs 80, 82, 84. According to one aspect, the power switch 74 may be a single pull, double throw switch. According to another aspect, the power switch may be any suitable switch to toggle battery pack 10 between the one and off conditions. Power switch 74 may be connected to top 30 of housing 12 such that an operable portion (i.e. the user operated switch itself) of power switch 74 is accessible from the exterior of the housing 12 while the internal power connections and switching mechanisms may extend through an aperture or opening defined in top 30 and into the interior 34 of housing 12. From here, the internal portion of power switch 74 may be operationally connected to the PCB 88 and/or other components within battery pack 10.

Alternating current (AC) plug 76 may be a standard AC plug which may be operable to connect an AC cord 136 (FIG. 13) between AC plug 76 and a standard wall outlet 138 (FIG. 13) as discussed further herein. According to one aspect, AC plug 76 may be a recessed male plug. As with power switch 74, AC plug 76 may be accessible from the exterior of housing 12 while the internal wiring and power components, as well as the connections to PCB 88 and other internal components, may be contained within interior 34 of housing 12.

Communications port 77 may be a data connector in operative communication with battery pack 10, PCB 88, and/or other components contained within battery pack 10 operable to connect to and communicate data to an external device for diagnostics, software updates, monitoring, or the like. According to one aspect, communications port 77 may allow a user to monitor one or more of the battery capacity, the charge level, the voltage, the ambient temperature inside housing 12 or any other desired aspect relating to battery pack 10 during the discharging and/or recharging thereof, as discussed further herein. Further according to this aspect, communications port 77 may utilize any suitable transmission protocol to transmit data to a remote display, including a computer, smartphone, tablet, or the like. According to one aspect, communications port may be a d-subminiature (d-sub) port, such as a DB-9 (DE-9) port. According to another aspect, communications port 77 may be any suitable data port or data connector as dictated by the desired implementation.

Readout 78 may be any type of readout allowing an operator or user of battery pack 10 to monitor various aspects of the battery pack 10 and the components contained therein. According to one aspect, readout 78 may be an analog readout. According to another aspect, readout 78 may be a digital readout. According to another aspect, readout 78 may further be or include an LCD, LED, or any other known type of display capable of communicating information regarding the state of battery pack 10. According to another aspect, readout 78 may include one or more gauges, such as a power gauge or temperature gauge or any other suitable gauge to further convey information regarding the various aspects of battery pack 10.

Readout 78 may allow a user to monitor one or more of the battery capacity, the charge level, the voltage, the ambient temperature inside housing 12 or any other desired aspect relating to battery pack 10 during the discharging and/or recharging thereof, as discussed further herein. Similar to power switch 74 and AC plug 76, a display of readout 78 may be accessible or viewable from the exterior of housing 12, while the internal components and wiring connections thereof may extend through an aperture in top 30 of body 14 and into the interior 34 of housing 12.

According to one aspect, readout 78 and/or battery pack 10 may include a wireless transceiver (not shown) in operative communication with battery pack 10, PCB 88, and/or other components contained within battery pack 10 to allow a user to monitor one or more of the battery capacity, the charge level, the voltage, the ambient temperature inside housing 12 or any other desired aspect relating to battery pack 10 during the discharging and/or recharging thereof, as discussed further herein. Further according to this aspect, wireless transceiver may utilize any suitable transmission protocol, such as WiFi, Bluetooth, or any other wireless transmission protocol, to transmit data to a remote display, including a computer, smartphone, tablet, or the like, to further facilitate remote monitoring of battery pack 10. According to another aspect, readout 78 may be replaced by wireless transceiver in that readout 78 may be removed from battery pack 10 and the monitoring of the various aspects of battery pack 10 may be wholly or substantially accomplished through use of a remote display. According to another aspect, wireless transceiver may replace or supplement communications port 77, if appropriate.

24V output 80, 36V output 82, and 48V output 84 may be industry standard and rated outputs as dictated by the desired implementation. For example, 24V output 80 may be an SB175 red industry standard 24V output, 36V output 82 may be an SB350 gray industry standard 36V output, and 48V output 84 may be an SB350 blue industry standard 48V output. According to another aspect, outputs 80, 82, and/or 84 may be any suitable output connector as dictated by the desired output voltage ratings and specific implementation of battery pack 10.

Each of outputs 80, 82, 84 may be connected to the top 30 of housing 12 such that they are accessible from the exterior of housing 12 for operable connection to an apparatus needing power as discussed further herein. Outputs 80, 82, 84 may further have a portion and/or electrical wiring that extends through apertures defined within top 30 (as discussed above) to allow for operational connection to PCB 88, battery cells 90, and other internal components of battery pack 10, as discussed below. Though shown with 24V output 80 positioned towards the rear side 24 of body 14 and 48V output 84 positioned towards the front side 22 of body 14. It will be understood that outputs 80, 82, 84 may be positioned in any order and/or position on top 30 of body 14, as desired.

Charger 86 may be a commercially available charger provided it is capable of adequately delivering power from the AC plug 76 to battery cells 90 as discussed further herein. According to one aspect, charger 86 may be variable in that it may allow an operator of battery pack 10 to switch between charged profiles for lead acid battery chemistries and/or lithium ion batteries through employment of the battery management system and/or charger system as discussed further herein. Charger 86 may be mounted to the interior side of front panel 16 through any suitable means including bolts, screws, rivets, welding, or the like. According to another aspect, charger 86 may be mounted to body 14 of housing 12 through employment of brackets, braces, or the like to maintain charger 86 within interior 34 of body 14 when front panel 16 is removed.

PCB 88 may be a standard printed circuit board and may include components to monitor and maintain battery cells 90 through both charging and discharging cycles as discussed further herein. PCB 88 may be in communication or otherwise connected to a non-transitory storage medium for storing a set of instructions thereon. PCB 88 may further include a processor, a logic or series of logics, operable to enact a set of instructions to perform the process or processes discussed below.

PCB 88 may further include a set of metal-oxide-semiconductor field-effect transistors (MOSFETs), relays, or other suitable devices to manage the flow of electrical energy through portable battery pack 10 as discussed further below. A first MOSFET or relay 110 may correspond to first battery stack 104, a second MOSFET or relay 112 may correspond to second battery stack 106, and a third MOSFET or relay 114 may correspond to a third battery stack 108 such that when a particular MOSFET or relay 110, 112, and/or 114 is turned on/closed, electrical current may be delivered to or from the corresponding battery stack. Accordingly, first, second, and third MOSFETs or relays 110, 112, and 114 may be normally turned off MOSFETs or normally open relays which do not allow a current to pass therethrough until turned on/closed.

PCB 88 may therefore further define the battery management system and charger system (hereinafter collectively referred to as “BMS”) which may allow proper operation of portable battery pack 10 through both charging and discharge cycles, as well as through monitoring and maintenance of the first, second, and third battery stacks 104, 106, 108, as discussed further herein.

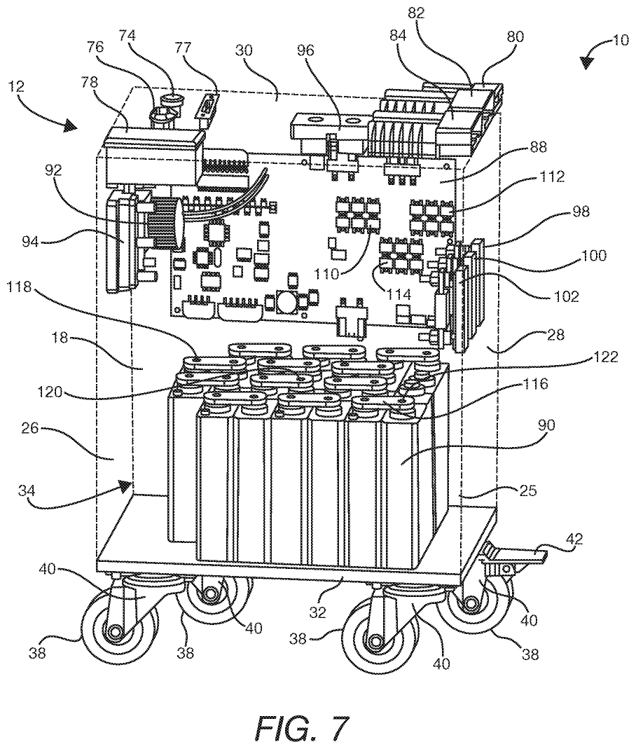

Battery cells 90 may be a series of individual and substantially identical battery cells 90 that are operationally connected through a plurality of busbars 116 allowing the first, second, and third battery stacks 104, 106, 108 to be formed therefrom. Specifically, the first battery stack 104 may be a lower stack that is rated at 24V and may include seven individual battery cells 90 with a 24V tap out 118 at the seventh battery cell (battery cells may be counted from 1 to 13 beginning with the right rear corner of housing 12 as depicted in FIG. 7 and moving counterclockwise therefrom—thus the 13^{th} cell would be in the right front corner of housing 12 in FIG. 7). Second battery stack 106 may be a middle stack that is rated at 12V and may include three individual battery cells 90. Second battery stack 106 may be combined with first battery stack 104 to provide a 36V current via a 36V tap out 120 at the tenth battery cell 90 within portable battery pack 10. Third battery stack 108 may be a 12V upper stack which may also include three individual battery cells 90. Third battery stack 108 may be combined with first and second battery stacks 104 and 106 to provide a 48V current via a 48V tap out 122 at the thirteenth battery cell 90 in battery pack 10. According to one aspect, tap outs 118, 120, and 122 may be the busbars 116 at the corresponding locations within battery pack 10 (i.e. seventh, tenth, and thirteenth battery cells 90). According to another aspect, standard terminal connections or any other suitable connection may be provided as tap outs 118, 120, and/or 122 as desired.

The plurality of busbars 116 may connect individual cells 90 to create the first, second, and third battery stacks 104, 106, 108 such that the first battery stack 104 which is the 24V lower stack may draw from its seven individual battery cells 90 to provide 24V current through 24V output 80 as discussed further herein. Second battery stack 106 may draw power from its three individual battery cells 90 as well as the seven cells 90 of first battery stack 104 to produce a combined 36V current through 36V output 82 as discussed further herein. Similarly, third battery stack 108 may draw from its three individual battery cells 90 as well as the ten previous battery cells 90 of first battery stack and second battery stack 104, 106 combined to produce a 48V current through 48V output 84 as discussed further herein.

Battery cells 90 including first battery stack 104, second battery stack 106, and third battery stack 108 may be in further connection with a contactor 92, common ground 94, and shunt 96. Specifically, all three battery stacks 104, 106, 108 may connect to contactor 92 which may be a commercially available electric contactor operable to control the electrical power circuit of battery pack 10 as discussed further herein.

Similarly, each of first, second, and third battery stacks 104, 106, 108 may be connected to common ground 94 to properly ground battery cells 90. Open terminals provided on the first and thirteenth battery cells 90 (right rear and right front as depicted in FIG. 7 and discussed above) are without a busbar 116 to allow for connection to the common ground 94.

Battery cells 90 may include different types of rechargeable batteries as known in the art. In one embodiment the battery cells 90 may include nickel cadmium (NiCd) batteries. The active components of a rechargeable NiCd battery in the charged state consist of nickel hydroxide (NiOOH) as the positive electrode and cadmium (Cd) as the negative electrode. For the electrolyte, an alkaline electrolyte such as potassium hydroxide (KOH) is commonly used, though other alkaline electrolytes may be implored such as sodium hydroxide (NaOH) or lithium hydroxide (LiOH). NiCd batteries have low internal resistance, very good current conducting properties, can supply extremely high currents, can be recharged rapidly. Further, NiCd cells are hearty and capable of sustaining temperatures down to −20° C. and up to 45° C. The selection of the separator, or the permeable membrane placed between the anode and cathode and the alkaline electrolyte (KOH, LiOH, NaOH) influence the voltage conditions in the case of a high current discharge, the service life, and the overcharging capability of a NiCd battery. In the case of misuse, a very high-pressure may arise quickly. For this reason, NiCd cells require a safety valve. NiCd cells generally offer a long service life thereby ensuring a high degree of economy.

NiCd cells have a nominal cell potential of 1.2 V. Further, NiCd batteries may be charged at several different rates, depending on how the cell was manufactured. The charge rate is measured based on the percentage of the amp-hour capacity the battery is fed as a steady current over the duration of the charge. Regardless of the charge speed, more energy must be supplied to the battery than its actual capacity, to account for energy loss during charging, with faster charges of NiCd batteries being more efficient. For example, an “overnight” charge, might consist of supplying a current equal to one tenth the amperehour rating for 14-16 hours; that is, a 100 mAh battery takes 10 mA for 14 hours, for a total of 140 mAh to charge at this rate. At the rapid-charge rate, done at 100% of the rated capacity of the battery in 1 hour, the battery holds roughly 80% of the charge, so a 100 mAh battery takes 125 mAh to charge (thus charged to full approximately 1 hour and fifteen minutes). The faster the NiCd battery is charged, the greater the risk of the cells overheating and venting due to an internal overpressure condition as the cell's rate of temperature rise is governed by its internal resistance and the square of the charging rate. For example, at a four times rate, the amount of heat generated in the cell is sixteen times higher than the heat at the one times rate (4²=16 vs. 1²=1). A further downside to faster charging is the higher risk of overcharging, which can damage the battery and the increased temperatures the cell has to endure (which potentially shortens its life).

When NiCd batteries are not under a load or charge, they will discharge at a rate of approximately 10% a month if kept approximately at room temperature. This rate increases the higher the temperatures increase. Thus, if the NiCd battery is desired to be unused for a long period of time, it is prudent to discharge the battery down to approximately 40% of capacity and stored in a cool and dry environment.

In another embodiment, the battery cells 90 are nickel metal hydride (NiMH) batteries. The active components of a rechargeable NiMH battery in the charged state consist of nickel hydroxide (NiOOH) in the positive electrode and a hydrogen storing metal alloy (MH) in the negative electrode as well as an alkaline electrolyte, such as KOH, LiOH, NaOH electrolyte. Hydrophilic polyolefin nonwovens are used for separation. The metal M in the negative electrode of a NiMH cell is an intermetallic compound, which is a type of metallic alloy that forms a solid-state compound which exhibits defined stoichiometry and ordered crystal structure. Many different compounds have been developed for NiMH batteries application, but those that are most suited for current use fall into two distinct classes. The most common is AB₅, where A is a rare-earth mixture of lanthanum, cerium, neodymium, praseodymium, and B is nickel, cobalt, manganese, or aluminum. Some NiMH cells use higher-capacity negative electrode materials based on AB₂ compounds, where A is titanium or vanadium, and B is zirconium or nickel, modified with chromium, cobalt, iron, or manganese. Any of these compounds serve the same role, reversibly forming a mixture of metal hydride compounds. Compared to rechargeable NiCd batteries, NiMH batteries have a higher energy density per volume and weight.

The charging voltage of NiMH batteries is in the range of 1.4-1.6 V per cell. In general, a constant-voltage charging method cannot be used for automatic charging. When fast-charging, it is advisable to charge the NiMH cells with a smart battery charger to avoid overcharging, which can damage cells. The simplest of the charging methods for NiMH batteries is done with a fixed low current, with or without a timer. Most manufacturers claim that overcharging is safe at very low currents. Low currents are generally below one tenth of the capacity of the battery divided by an hour.

NiMH batteries may also be charged fast in what is referred to as the ΔV method. In order to prevent cell damage, fast chargers must terminate their charge cycle before overcharging occurs. One method is to monitor the change of voltage with time. When the battery is fully charged, the voltage across its terminals drops slightly. A charger should be able to this voltage drop and stop charging. However, the voltage drop is not very pronounced for NiMH and can be non-existent at low charge rates, which can make the ΔV method unreliable.

An alternative way to charge NiMH batteries is called the ΔT method, or temperature-change method. The temperature-change method is similar in principle to the ΔV method. The charging voltage stays nearly constant so the constant-current charging delivers energy at a near-constant rate. When the cell is not fully charged, most of this energy is converted to chemical energy. However, when the cell reaches full charge, most of the charging energy is converted to heat. This increases the rate of change of battery temperature, which can be detected by a sensor such as a thermistor.

Historically, NiMH cells have had a somewhat higher self-discharge rate (equivalent to internal leakage) than NiCd cells. The self-discharge rate varies greatly with temperature, where lower storage temperature leads to slower discharge and longer battery life. The self-discharge is 5-20% on the first day and stabilizes around 0.5-4% per day at room temperature. But at 45° C. it is approximately three times as high.

When overcharged at low rates, oxygen produced at the positive electrode passes through the separator and recombines at the surface of the negative electrode. Hydrogen evolution is suppressed, and the charging energy is converted to heat. This process allows NIMH cells to remain sealed in normal operation and to be maintenance-free.

In another embodiment, the battery cells 90 are lithium ion batteries. The term lithium ion battery refers to a rechargeable battery where the negative electrode (anode) and positive electrode (cathode) materials serve as a host for the lithium ion (Li+). Lithium ions move from the anode to the cathode during discharge and are intercalated, or inserted into voids in the crystallographic structure, into the cathode. A traditional cathode may be graphite. The lithium ions then reverse direction during charging. Since lithium ions are intercalated into host materials during charge or discharge, there is no free lithium metal within a lithium-ion cell. In a lithium ion cell, alternating layers of anode and cathode are separated by a porous film type of separator. An electrolyte composed of an organic solvent and dissolved lithium salt provides the media for lithium ion transport. For most commercial lithium ion cells, the voltage range is approximately 3.0 V (discharged, or at a 0% state-of-charge, SOC) to 4.2 V (fully charged, or 100% SOC).

Lithium ion batteries can be a safety hazard as the organic solvent is flammable and if damaged or incorrectly charged can lead to explosions and fires. Current research is focused in the area of non-flammable electrolytes as a pathway to increased safety based on the flammability and volatility of the organic solvents used in the typical electrolyte. There has been progress in making aqueous lithium-ion batteries, ceramic solid electrolytes, polymer electrolytes, ionic liquids, and heavily fluorinated systems, all of which increase safety of the lithium ion battery.

Charging for a single lithium ion cell vs entire lithium ion batteries are slightly different. A single lithium ion cell is charged in two stages, the constant current phase and then the constant voltage stage. The constant current phase is when a charger will apply a constant current to the cell leading to the battery steadily increasing voltage, until the voltage limit is reached within the cell. The constant voltage phase is when the charger applies a voltage equal to the maximum cell voltage, as the current gradually declines towards 0, until the current is below a set threshold of the initial constant charge current. That threshold is in generally about 3%.

Charging for an entire lithium ion battery consists of three stages, the constant current stage, the balance stage, and the constant voltage stage. Similar to the process for the single cell, the constant current stage applies a constant current to the battery at a steadily increasing voltage until the voltage limit per cell of the battery is reached. Then, the balance stage occurs as the charge reduces the charging current, while the state of the charge of individual cells is brought to the same level by a balancing circuit. Some chargers skip this stage, and other chargers may accomplish this by charging each cell independently. Similar to the NiCd and NIMH batteries discussed above, lithium ion batteries will gradually self-discharge at about 1.5-2% per month.

Common lithium ion battery cell chemistries that are used in an exemplary embodiment may include Lithium Cobalt Oxide (LiCoO₂, LCO), Lithium Manganese Oxide (LiMn₂O₄, LMO), Lithium Nickel Manganese Cobalt Oxide (LiNiMnCoO₂, NMC), Lithium Iron Phosphate (LiFePO₄, LFP), Lithium Nickel Cobalt Aluminum Oxide (LiNiCoAlO₂, NCA), and Lithium Titanate (Li₂TiO₃, LTO) as well as mixtures of the batteries thereof.

Charge and discharge rates of any battery are governed by C-rates. The capacity of a battery is commonly rated at 1C, meaning that a fully charged battery rated at 1 Ah should provide 1 A for one hour. The same battery discharging at 0.5C should provide 500 mA for two hours, and at 2C it delivers 2 A for 30 minutes. Losses at fast discharges reduce the discharge time and these losses also affect charge times.

Traditional voltages of LCO cells is 3.7V with 3.8V nominal voltage with an operating range of 3.0-4.2V per cell. The charge rate is traditionally 0.7-1.0C charging to 4.2V with a three-hour charge that is typical. If the charge current goes above 10, the life of the cell is reduced. The traditional discharge rate is 1C, with a 2.5V cut off. If the discharge current goes above 1C, the life of the cell is reduced.

Traditional voltages of LMO cells is 3.7V nominal voltage with a typical operating range of 3.0-4.2V per cell. The charge rate is traditionally 0.7-1.0C with a 3C maximum. Most cells charge to 4.2V. The discharge rate is traditionally 1C, but can be up to 10C with some cells, or a 30C pulse. The cut off for discharge is 2.5V.

Traditional voltages of NMC cells is 3.6V with 3.7V nominal voltage with an operating range of 3.0-4.2V, or higher per cell. The charge rate is traditionally 0.7-1.0C and most cells charge to 4.2V, some may charge to higher values. A three-hour charge is typical. The discharge rate is traditionally 1C, but it may be 2C with some cells with a cut off for discharge at 2.5V.

Traditional voltages of LFP cells is 3.2V with 3.3 nominal voltage with a typical operating range of 2.5-3.65V. The charge rate is traditionally 1C and most cells charge to 3.65V, with a three-hour charge being typical. The discharge rate is 1C but may be 25C in some cells or a 40C pulse. The cut off is 2.5V, lower than 2V causes damage.

Traditional voltage of NCA cells is 3.6V nominal with a typical operating range of 3.0-4.2V. The charge rate is traditionally 0.7C that most cells charge to 4.2V, with a three-hour charge being typical. The discharge rate is 1C with a 3V cut off, and high discharge rate may shorten the battery life.

Traditional voltage of LTO cells is 2.4V nominal with a traditional operating range of 1.8-2.85V. The charge rate is traditionally 1C, but may be 5C at a maximum. The cells charge to 2.85V. The discharge rate allows for 10C or a 30C pulse, with a 1.8V cut off.

In another embodiment, the battery cells 90 are lead acid batteries. In a discharged state, both a positive and a negative plates of a lead acid battery are lead (II) sulfate, PbSO₄, separated by a dilute sulfuric acid (H₂SO₄). At the negative plate, two electrons are conducted which then gives the negative plate a negative charge by the following reaction (1):

Pb(s)+HSO₄⁻(aq)→PbSO₄(s)+H⁺(aq)+2e⁻ (1)

As the electrons accumulate they create an electric field which attracts hydrogen ions and repels sulfate ions. This leads to a double-layer near the surface. The hydrogen ions screen the charged electrode from the solution which limits further reaction unless charge is allowed to flow out of electrode.

At the positive plate, the following reaction (2) occurs:

Pb(s)+PbO₂(s)+2H₂SO₄(aq)→2PbSO₄(s)+2H₂O(l) (2)

When the lead acid battery is in its fully charged state, the negative plate consists of just lead and the positive plate consists of lead dioxide. At this time, the electrolyte has a high concentration of sulfuric acid.

Wood, rubber, glass fiber mat, cellulose, and PVC or polyethylene plastic have been used to make separators within lead acid batteries. Wood was the original choice, but deteriorated in the acid electrolyte. Therefore, rubber separators which are stable in battery acid as well as providing valuable electrochemical advantages that other materials cannot. Lead acid batteries have a self-discharge rate of approximately 3-20% a month. A lead-acid battery's nominal voltage is 2V for each cell. For a single cell, the voltage can range from 1.8V when loaded at full discharge, to 2.1 V in an open circuit at full charge.

In an exemplary embodiment, the battery cells 90 are one single type of battery, or are mixtures of the types discussed above.

Shunt 96 may be an electrical shunt or shunt resistor which may be used for current sensing to insure proper operation of battery pack 10 as discussed further herein. Shunt 96 may be a standard and commercially available electrical current sensing shunt suitable for the desired implementation thereof.

First battery stack 104, which may be the 24V bottom stack, may be operationally connected to a 24V fuse 98. Similarly, second battery stack 106 may be operationally connected to a 36V fuse 100 and third battery stack 108 may be operationally connected to a 48V fuse 102. Each of 24V, 36V, and 48V fuses 98, 100, 102 may be standard fuses rated for the appropriate voltage thereof. According to one aspect, 24V fuse 98, 36V fuse 100, and 48V fuse 102 may be any suitable type of fuse including AC fuses or DC fuses or any known type thereof suitable for the desired implementation.

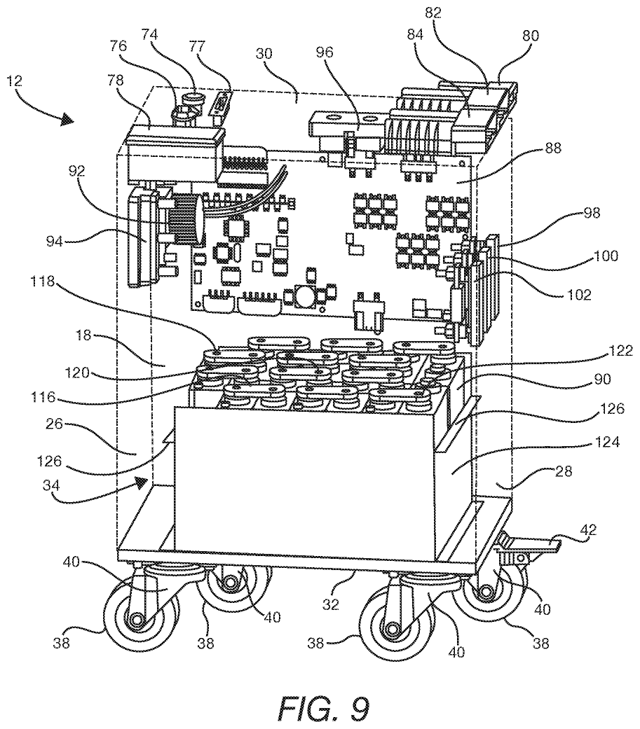

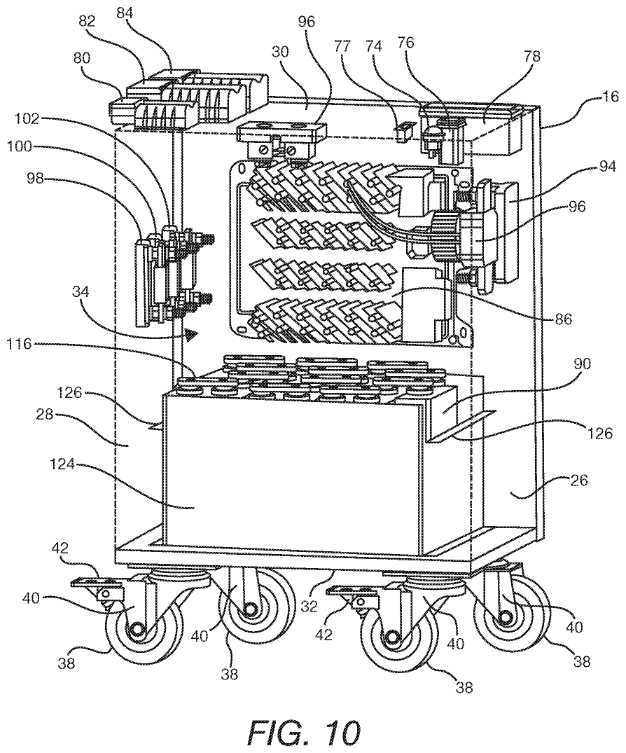

Battery cells 90 of battery pack 10 may further be contained within a battery well 124 (best seen in FIGS. 9 and 10) which may be affixed to body 14 of housing 12 through any suitable means as dictated by the desired implementation. Battery well 124 may further include one or more flanges 126 which may connect to battery straps 128 to further secure battery cells 90 within battery well 124. These battery straps 128 may be metal, rubber, or any other suitable material and may extend over and across each of the battery cells 90 and may affix or otherwise attach to flanges 126 of battery well 124 through any suitable means. According to one aspect, battery straps 128 may be screwed, bolted, riveted, adhered, clipped, clamped, or otherwise connected to flanges 126 of battery well 124.

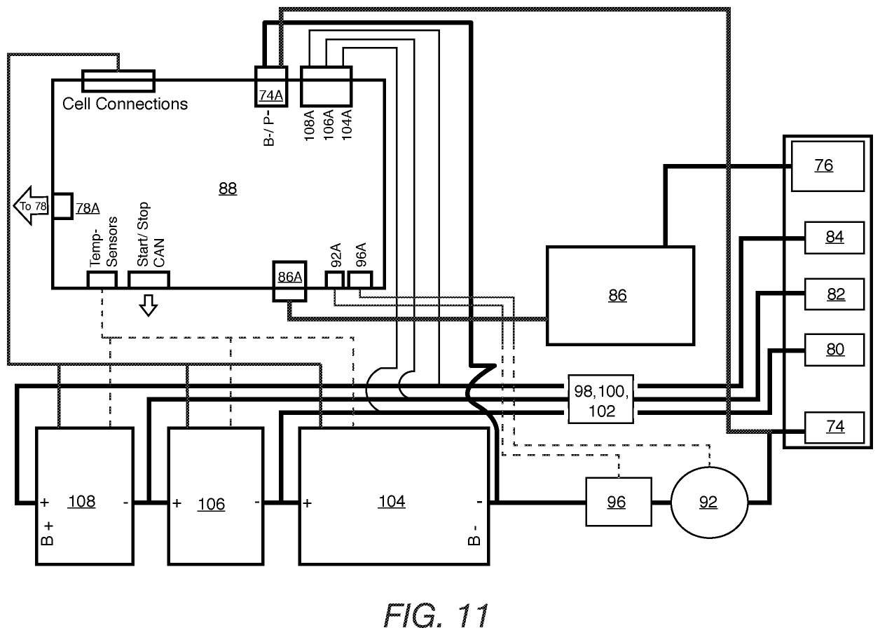

With reference to FIG. 11, a wiring diagram for battery pack 10 is shown indicating the connections between the various components thereof. While each component illustrated in FIG. 15 is labeled with the corresponding reference numbers of those components discussed and illustrated throughout, it will be recognized and understood that the corresponding circuit board connections and/or elements on PCB 88 are labeled with the corresponding number followed by A. For example, charger is indicated in FIG. 11 as reference 86 while the charger connector on PCB 88 is indicated with reference 86A. Wiring indicated in FIG. 11 and used throughout battery pack 10 may be standard and commercially available electrical wiring suitable for the specific application, and may vary depending on the specific implementation of battery pack 10.

Having thus described the elements and components of battery pack 10, the operation and method of use will now be discussed.

At its most basic, battery pack 10 may be a portable battery pack that may be used to power any electrical components for operation. Therefore, the most basic method of use for battery pack 10 may further inform how an operator or user thereof would interact with battery pack 10 on a day-to-day basis. First, an operator or user desiring to utilize battery pack 10 may first retrieve battery pack 10 from a storage location and may extend retractable handle 44 to allow the user to maneuver battery pack 10 to the desired location of use. If properly stored with brakes 42 applied, user may release brakes 42 before maneuvering battery pack 10 as desired.

Once in the desired location, the user may toggle power switch 74 to the “on” position thereby powering up battery pack 10 (the internal processes undergone by battery pack 10 during use and charging are discussed in more detail below). From here, the user may connect to the desired output, i.e., the 24V output 80, 36V output 82, or 48V output 84, and to the associated system or apparatus being powered. The specific output 80, 82, or 84 chosen for use may be dictated by the power requirements of the apparatus being powered by battery pack 10.

Battery pack 10 then may provide an appropriate current through the connected output to power an associated piece of equipment as desired until no longer necessary. At the point that battery pack 10 is no longer needed, the user may disconnect the appropriate output 80, 82, or 84 from the associated equipment and may toggle power switch 74 to the “off” position. Battery pack 10 may then be wheeled to a new location for further use with an additional apparatus or apparatuses, or may be moved back to the storage location for charging and/or storage until needed again.

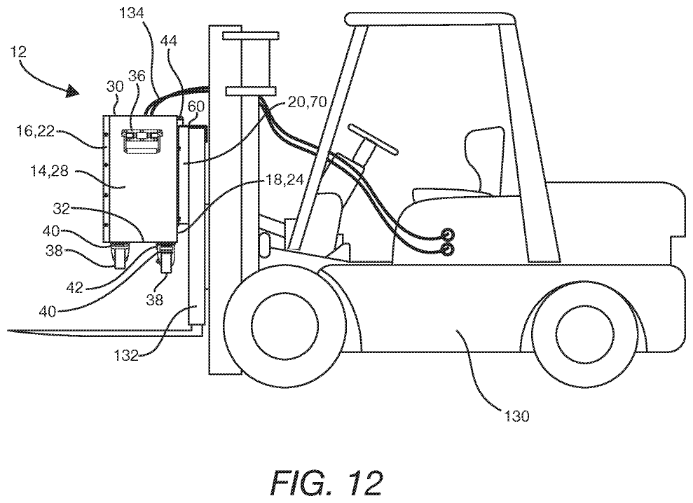

To illustrate this method by way of one non-limiting example, an apparatus that may require power in a manner similar to that described herein may be one or more forklifts 130, which may require electrical power to drive or otherwise operate. A generic version of a forklift is illustrated in FIG. 12 with battery pack 10 connected thereto. According to this example, battery pack 10 may be wheeled to the location of the forklift 130 and may lifted using handles 36 to hook the left and right mounting hooks 58, 60 to a fork or fork frame 132 of forklift 130. From there, power cables 134 may be connected on a first end to the appropriate power output, i.e., 24V output 80, 36V output 82, or 48V output 84, as dictated by the power requirement of forklift 130 and may be connected on a second end to the power input of forklift 130. Forklift 130 may then be operated normally, including driven to various points on the manufacturing floor and/or to an area for storage prior to delivery and installation of a permanent battery therein. At the time forklift 130 is no longer in need of power, power cables 134 may be removed from battery pack 10 and/or from a power input on forklift 130 and battery pack 10 may be lifted up and away from fork frame 132 for further use with additional equipment or for charging.

By way of a second non-limiting example, after providing power to the first forklift 130 from the previous example, battery pack 10 may then be transported to and used to power a second forklift 130 or similar apparatus with a second power requirement. The second power requirement may differ from the power requirement (first power requirement) of the first forklift from the previous example, and may dictate that the user connects to a different output 80, 82, or 84 than with the first forklift 130. For example, the first forklift 130 may have had a first power requirement of 24V while the second apparatus/forklift 130 may have a second power requirement of 36V. Thus, the user may first employ the 24V output 80 for the first forklift 130 and the 36V output 82 for the second forklift 130. Once the second forklift 130 is no longer in need of power, the battery pack 10 may be quickly disconnected and transported to the next location.

According to yet another example, the next location may be a third forklift 130 or apparatus with a third power requirement, e.g. 48V, which may then be powered by battery pack 10 via the 48V output 84. Once the battery pack is again no longer needed, it may be quickly and easily disconnected and transported to another apparatus, or alternatively to a storage location for re-charging.

When battery pack 10 is to be recharged, it may be transported to a storage/charging location where it may be connected to a standard wall outlet 138 by an AC cable 136, as best seen in FIG. 13. Specifically, a first end of the AC cable 136 may plug into AC plug 76 on top 30 of battery pack 10 with a second end of the AC cable 136 connecting to a wall outlet 138 or other suitable external power source as dictated by the desired implementation. Battery pack 10 may be left in this condition, with AC cable 136 attached thereto, to allow battery cells 90 within battery pack 10 to be charged to a full capacity charge level. Battery pack 10 may be stored while connected to the external power source 138, or may alternatively be disconnected therefrom once the full capacity charge level is reached. According to another aspect, battery pack 10 may receive a partial charge before being used to power additional equipment and/or apparatuses.

These general methods of use for battery pack 10 inform the overall manner in which battery pack 10 may be employed; however, it will be further understood that battery pack 10 may be applied to any situation where power is desired according to these or similar methods, including to power other equipment and/or apparatuses not explicitly discussed or described herein.

With reference now to the specific internal process or processes of battery pack 10, the detailed internal operation thereof will now be described. Specifically, these processes may inform the use of battery pack 10 with particular reference to the discharging and recharging cycles thereof.

With respect to discharging of battery pack 10, the process may occur beginning with the powering on of battery pack 10 by toggling power switch 74 into an “on” position. At powering on, in succession, each of first MOSFET or relay 110, second MOSFET or relay 112, and third MOSFET or relay 114 may be tested by the BMS which may turn on/close each MOSFET or relay 110, 112, and 114 to complete a power circuit to each respective battery stack 104, 106 and 108. This may allow the shunt 96 to sense the current coming from each battery stack 104, 106, and 108, and to determine the health and charge level thereof. As the MOSFETs or relays 110, 112, 114 are turned off/opened and then turned on/closed accordingly, if the current sensing through shunt 96 indicates that battery cells 90 are operational with an acceptable charge level, as well as no current faults detected, battery pack 10 may then be prepared for normal operation. This “startup” process or housekeeping step may be automatically performed each time battery pack is switched on with power switch 74.

Once battery pack is operational (and has been transported to the desired location for use, as described above), the user may connect to the one of the 24V output 80, 36V output 82, or 48V output 84, and the BMS the appropriate MOSFET or relay 110, 112, 114 may connect allowing power to be supplied through the appropriate output. For example, if a user connects to the 24V output 80, first MOSFET or relay 110 may turn on/close to allow current to flow through the 24V output 80 from first battery stack 104. As power is discharged, the BMS carried by PCB 88 may monitor the charge conditions of first battery stack 104, including the discharge rate and the charge level thereof.

Through constant monitoring of each battery stack 104, 106, and/or 108 during discharge, the BMS may insure that the individual battery cells 90 remain healthy and do not exceed allowable thresholds of operation, thus extending the life of each battery cell 90. For example, when the BMS monitors for the charge levels of each individual battery cell 90, it may ensure that the charge level remains above a safety threshold, below which damage to the battery cell 90 may occur. This threshold may vary depending on the size and type of battery cell 90 used (e.g. lithium-ion vs NiCd vs NiMH vs lead acid) but may be predetermined and preset according to the particular implementation of battery pack 10.

According to one non-limiting example, each individual battery cell 90 may have a threshold of 2.7 volts wherein any discharge below that level may result in damage to the battery cell 90. Accordingly, BMS may set a safety threshold at 2.9 volts to prevent over-discharge of battery cells 90 and may interrupt the current flowing from battery cells 90, or more particularly from the appropriate battery stack 104, 106, and/or 108, when the charge level falls below this threshold. Similarly, BMS may monitor other conditions of battery cells 90 or the battery pack 10 such as the aforementioned discharge rate, the temperature of the cells 90, or the ambient temperature within housing 12 and again may interrupt current discharge if any of these parameters fall below or exceed associated thresholds, as appropriate.

As battery stacks 104, 106, and/or 108 continue to discharge their stored energy; BMS will continue to monitor the state of individual battery cells 90 and may direct other non-used cells 90 with a higher charge level to redistribute their charge to the cells 90 of first battery stack 104 as they are being depleted, analogous to using a full water glass to fill other water glasses with a lower water level. This may be done to help prolong the usable discharge cycle of any one individual battery cell 90 or battery stack 104, 106, 108, as well as to protect the battery cells 90 from damage caused by over-discharge. Once the discharge demand is removed from first battery stack 104, BMS may continue to allow or direct charge to be redistributed amongst the individual battery cells 90 to help balance out the charge across each of the first, second and third battery stacks 104, 106, 108. This process may continue until battery pack 10 is connected to a power source, such as a wall outlet 138 through AC cable 136 and/or AC plug 76 to recharge battery cells 90 therein.

As first battery stack 104 is used during all discharge cycles, regardless of which output 80, 82, 84 is employed, it will understandably be depleted most often and to the lowest charge levels. Similarly, second battery stack 106 is used for both the 36V output 82 and the 48V output 84, and is likely to be depleted before the third battery stack 108. Accordingly, the three battery stacks 104, 106, and 108 are likely to be depleted at different rates. The use of BMS to redistribute power among the battery cells 90 may further protect the battery cells 90 and prolong their usable life by ensuring that all cells go through depletion (i.e. the cells 90 of third battery stack 108 will be partially depleted to recharge the other cells 90) even when those cells are not directly used via the corresponding output 80, 82, or 84.

Further, when battery pack 10 is put through multiple discharge cycles between recharge cycles, each of the three battery stacks 104, 106, 108 may be depleted at different rates depending upon which output 80, 82, 84 is used for any given discharge cycle. For example, if battery pack 10 is connected to a piece of equipment requiring a 24V current, then first battery stack 104 will begin to discharge as it delivers power through the 24V output 80. If battery pack 10 is then disconnected from the 24V equipment and connected to a 36V piece of equipment, first battery stack 104 and second battery stack 106 will discharge through the 36V output 82 thereby depleting the battery cells 90 of each of first and second battery stack 104, 106. As first battery stack 104 has been used in both of these exemplary discharge cycles, it will be depleted more than second battery stack 106, while third battery stack 108 which was not used for these two exemplary discharge cycles should retain a full or nearly full charge. Thus, as discussed above, BMS can begin reallocating charge from third battery stack 108 to first and/or second battery stacks 104, 106 to bring their charge levels up and to balance out the charge of the cells 90 in each of the three battery stacks 104, 106, 108.

Further, since BMS will monitor the charge levels of each of the first, second, and third battery stacks 104, 106, and 108 during discharge, should any fall to or below the safety threshold charge level, the output of power therefrom will be disconnected. Since first battery stack 104 is used in all discharge cycles, should the individual battery cells 90 of first battery stack 104 fall to the safety threshold, discharge will be ceased regardless of which output 80, 82, 84 is being used and regardless of whether or not second and/or third battery stacks 106, 108 retain charge levels above the minimum safety threshold. This is to prevent damage to any individual battery cell 90 of battery pack 10 and to further prolong the usable life thereof.

While BMS also attempts to maintain an even charge level across all battery cells 90, it will be understood that a discharge cycle may deplete the stored energy within a particular battery stack 104, 106, 108 faster than BMS can reallocate a charge from neighboring cells 90. For example, discharging the first battery stack 104 through the 24V output 82 will reduce the stored energy within first battery stack 104 faster than BMS can transfer the stored energy from the battery cells 90 of second and third battery stacks 106, 108, therefore, it will be understood that the reallocation of power between cells may occur at a lower rate than a normal discharge, and cannot be relied upon to maintain the battery cells alone. Instead, this reallocation is to supplement normal recharging cycles, which will now be discussed.

When battery pack 10 is no longer being used to provide power as discussed herein, it may be connected to an external power source, such as a wall outlet 138, via AC cable 136 and AC plug 76 to begin a recharge cycle to bring the individual battery cells 90 of first, second and third battery stacks 104, 106,108 back to a charged condition. During a recharge cycle, the BMS may manage the manner in which the battery stacks 104, 106, 108 are charged such that the stack 104, 106, 108 with the lowest charge level, which will most often be first battery stack 104 due to it being used in every discharge cycle, will be brought up to a level substantially equal to the charge level of the stack 104, 106, 108 with the second lowest (or second highest) charge level. This may most often be second battery stack 106 as it is utilized in two of the three discharge cycle scenarios. Once both the battery stacks with lowest charge level and second lowest charge level (typically 104 and 106) reach the charge level of the battery stack 104, 106, 108 with the highest charge level (which will most often be third battery stack 108) BMS may then direct all three battery stacks 104, 106, 108 to be charged simultaneously until they reach full capacity.

For example, where all three battery stacks 104, 106, 108 have been depleted at different rates and therefore have different levels of charge, BMS would first direct the first MOSFET or relay 110 to turn on/close to direct current from the charger 86 (via AC plug 76) through the MOSFET or relay 110 and to first battery stack 104 until it reached the charge level of second battery stack 106. At this point the BMS would turn on/close the second MOSFET or relay 112 to direct current to the first and second battery stacks 104, 106. Once both first and second battery stacks 104, 106 reach the charge level of third battery stack 108, MOSFET or relay 114 may then be turned on/closed to direct power into all three battery stacks 104, 106, 108, thereby charging all three simultaneously until they reach the full capacity charge level.

As the battery stacks 104, 106, 108 are being charged, the BMS will continue to monitor the charge levels thereof. If the BMS detects that the battery cells 90 of any given battery stack 104, 106, 108 reach full capacity sooner than the battery cells 90 of one of the other battery stacks 104, 106, 108, BMS may turn off/open the appropriate MOSFET or relay to interrupt charging to the stack(s) 104, 106, and/or 108 that have reached full capacity, while continuing to allow the other stack(s) to charge. For example, if the cells 90 of third battery stack 108 reach full capacity, MOSFET or relay 114 may be turned off/opened to stop current from flowing into those cells while continuing to charge first and second battery stacks 104 and 106. Once second battery stack 106 reaches full charge, MOSFET or relay 112 may be turned off/opened to interrupt the current, and first stack 104 may continue to charge. Once the cells 90 of first stack 104 reach full charge, BMS may turn off/open all MOSFETs or relays 110, 112, and 114, to stop the recharging cycle completely and may disengage the charger 86.

During a recharge cycle, temperature sensors (not shown) may be optionally included within battery pack 10, within the individual battery cells 90, or in communication therewith, may monitor the temperature of each individual battery cell 90 and/or first, second or third battery stacks 104, 106, 108 collectively to insure the temperature thereof does not exceed safe levels. In the instance that one or more battery cells 90 of any of the three battery stacks 104, 106, 108 were to exceed a safe temperature, recharging would be interrupted by the BMS until all battery cells 90 were again below a safe temperature threshold.

According to one aspect, if all three battery stacks 104, 106, 108 have been sufficiently discharged such that all battery cells 90 fall below a charging threshold, which may be higher than the safety threshold, but low enough to ensure damage is not likely to occur, all three battery stacks 104, 106, 108 may be charged together regardless of the relative charge level differences therebetween. By way of non-limiting example, and according to one aspect, if all three battery stacks 104, 106, 108 or more particularly, all individual battery cells 90, have a safety threshold of 2.9V, when all three stacks 104, 106, and 108 fall below a charge level of approximately 3.9V, all battery stacks 104, 106, 108 may be charged together.

In a further non-limiting example, the battery stacks 104, 106, 108 may all comprise the same type of batteries and may be charged together but a similar voltage. Similarly, they may be charged at different rates depending on the composition of the cells. During any given recharge cycle, all of the individual battery cells 90 will charge at their desired rates as the battery pack 10 that corresponds to The BMS allows proper operation of portable battery pack 10 through both charging and discharge cycles and may be programmed to recognize specific battery types and understand the properties of the batteries. In a further non-limiting example, data may be inputted into the battery pack 10 via the communications port 77 relating to the identification on the battery stacks 104, 106, 108.

For example, when the battery stacks 104, 106, 108 comprise LFP cells which operate at a typical operating range of 2.5-3.65V as well has having charge rate is traditionally 1C and most cells charge to 3.65V. The BMS could differentiate or be programmed to differentiate the battery stacks 104, 106, 108 from when the battery stacks 104, 106, 108 comprises NMC cells, which operate at a typical operating range of 3.0-4.2V, or higher, per cell. The charge rate of the NMC is traditionally 0.7-1.0C and most cells charge to 4.2V. The BMS would understand these different properties and be operative to charge and discharge at proper rates dependent on the battery type. These properties may be manually encoded into the BMS by an operator, or may be automatically determined based on sensors or other identifying indicia located on the cells of the battery stacks 104, 106, 108.

In a further non-limiting example, the cells of the battery stacks 104 106, 108 may be different and the BMS may be operative to treat the battery cells differently depending on their battery cell configuration.

In a further non-limiting example, during any given recharge cycle, all individual battery cells 90 will charge at the same rate as each battery cell 90 is contemplated to be identical to each other individual battery cell 90 within battery pack 10.

Once a recharge cycle has fully charged each of the first, second, and third battery packs 104, 106, 108, BMS may interrupt incoming power to prevent overcharging the battery cells 90 of battery pack 10 to prevent damage thereto. According to one aspect, BMS may completely disconnect the battery stacks 104, 106, 108 from the external power source, such as wall outlet 138, through turning off/opening MOSFETs or relays 110, 112, and/or 114, and/or disengaging the charger 86, and may maintain this status until and unless battery cells 90 fall below a predetermined capacity that is less than full capacity. At this point BMS may reconnect to the incoming power source by closing MOSFETs or relays 110, 112, and/or 114, and/or reengaging the charger 86 to bring those battery cells 90 back up to full capacity. According to another aspect, BMS may direct charger 86 to switch into a low flow/maintenance mode wherein a very low voltage current is consistently provided to battery cells 90 to maintain a full charge without causing further damage thereto.

According to another embodiment, battery pack 10 may utilize multiple BMSs that may be overseen by a higher level system. For example, each of first, second, and third battery stacks 104, 106, 108 may each have a dedicated BMS to monitor various battery characteristics, such as capacity, temperature, state of charge, charge level, and the like. Each of these individual BMSs may then be overseen by and/or managed by primary or higher level BMS which may be used to direct the discharge cycles and/or recharge cycles thereof.

Although described and discussed herein using three outputs, namely, 24V output 80, 36V output 82, and 48V output 84, it will be understood that portable battery pack 10 may utilize more or less than three outputs 80, 82, 84 including outputs of different voltages besides those described herein, without deviation of the scope thereof. It will be further understood that the number size and/or capacity of individual battery cells 90 may be amended appropriately to accommodate differing outputs. For example, battery cells 90 may be provided in number and/or size or capacity to allow for lesser voltage outputs, such as a 12V output, or greater voltage outputs, such as a 60V or 72V output, as dictated by the desired implementation.

As further discussed herein, battery pack 10 is disclosed for use with equipment, such as forklifts 130, power forks, pallet jacks, and other similar industrial machinery. However, it will be further understood that battery pack 10 may be readily adapted for use with any electrical system or any component of any type requiring portable and/or temporary electrical power. Battery pack 10 may be further configured for use in automotive and/or marine applications and housing 12 may be modified for such applications. For example, if battery pack 10 is adapted for marine use, housing 12 may be modified to include watertight seals and construction between the various parts and components thereof.

Also, various inventive concepts may be embodied as one or more methods, of which an example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

While various inventive embodiments have been described and illustrated herein, those of ordinary skill in the art will readily envision a variety of other means and/or structures for performing the function and/or obtaining the results and/or one or more of the advantages described herein, and each of such variations and/or modifications is deemed to be within the scope of the inventive embodiments described herein. More generally, those skilled in the art will readily appreciate that all parameters, dimensions, materials, and configurations described herein are meant to be exemplary and that the actual parameters, dimensions, materials, and/or configurations will depend upon the specific application or applications for which the inventive teachings is/are used. Those skilled in the art will recognize, or be able to ascertain using no more than routine experimentation, many equivalents to the specific inventive embodiments described herein. It is, therefore, to be understood that the foregoing embodiments are presented by way of example only and that, within the scope of the appended claims and equivalents thereto, inventive embodiments may be practiced otherwise than as specifically described and claimed. Inventive embodiments of the present disclosure are directed to each individual feature, system, article, material, kit, and/or method described herein. In addition, any combination of two or more such features, systems, articles, materials, kits, and/or methods, if such features, systems, articles, materials, kits, and/or methods are not mutually inconsistent, is included within the inventive scope of the present disclosure.

The above-described embodiments can be implemented in any of numerous ways. For example, embodiments of technology disclosed herein may be implemented using hardware, software, or a combination thereof. When implemented in software, the software code or instructions can be executed on any suitable processor or collection of processors, whether provided in a single computer or distributed among multiple computers. Furthermore, the instructions or software code can be stored in at least one non-transitory computer readable storage medium.

Also, a computer or smartphone utilized to execute the software code or instructions via its processors may have one or more input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computer may receive input information through speech recognition or in other audible format.

Such computers or smartphones may be interconnected by one or more networks in any suitable form, including a local area network or a wide area network, such as an enterprise network, and intelligent network (IN) or the Internet. Such networks may be based on any suitable technology and may operate according to any suitable protocol and may include wireless networks, wired networks or fiber optic networks.

The various methods or processes outlined herein may be coded as software/instructions that is executable on one or more processors that employ any one of a variety of operating systems or platforms. Additionally, such software may be written using any of a number of suitable programming languages and/or programming or scripting tools, and also may be compiled as executable machine language code or intermediate code that is executed on a framework or virtual machine.

In this respect, various inventive concepts may be embodied as a computer readable storage medium (or multiple computer readable storage media) (e.g., a computer memory, one or more floppy discs, compact discs, optical discs, magnetic tapes, flash memories, USB flash drives, SD cards, circuit configurations in Field Programmable Gate Arrays or other semiconductor devices, or other non-transitory medium or tangible computer storage medium) encoded with one or more programs that, when executed on one or more computers or other processors, perform methods that implement the various embodiments of the disclosure discussed above. The computer readable medium or media can be transportable, such that the program or programs stored thereon can be loaded onto one or more different computers or other processors to implement various aspects of the present disclosure as discussed above.

The terms “program” or “software” or “instructions” are used herein in a generic sense to refer to any type of computer code or set of computer-executable instructions that can be employed to program a computer or other processor to implement various aspects of embodiments as discussed above. Additionally, it should be appreciated that according to one aspect, one or more computer programs that when executed perform methods of the present disclosure need not reside on a single computer or processor, but may be distributed in a modular fashion amongst a number of different computers or processors to implement various aspects of the present disclosure.

Computer-executable instructions may be in many forms, such as program modules, executed by one or more computers or other devices. Generally, program modules include routines, programs, objects, components, data structures, etc. that perform particular tasks or implement particular abstract data types. Typically the functionality of the program modules may be combined or distributed as desired in various embodiments.

Also, data structures may be stored in computer-readable media in any suitable form. For simplicity of illustration, data structures may be shown to have fields that are related through location in the data structure. Such relationships may likewise be achieved by assigning storage for the fields with locations in a computer-readable medium that convey relationship between the fields. However, any suitable mechanism may be used to establish a relationship between information in fields of a data structure, including through the use of pointers, tags or other mechanisms that establish relationship between data elements.

All definitions, as defined and used herein, should be understood to control over dictionary definitions, definitions in documents incorporated by reference, and/or ordinary meanings of the defined terms.

“Logic”, as used herein, includes but is not limited to hardware, firmware, software and/or combinations of each to perform a function(s) or an action(s), and/or to cause a function or action from another logic, method, and/or system. For example, based on a desired application or needs, logic may include a software controlled microprocessor, discrete logic like a processor (e.g., microprocessor), an application specific integrated circuit (ASIC), a programmed logic device, a memory device containing instructions, an electric device having a memory, or the like. Logic may include one or more gates, combinations of gates, or other circuit components. Logic may also be fully embodied as software. Where multiple logics are described, it may be possible to incorporate the multiple logics into one physical logic. Similarly, where a single logic is described, it may be possible to distribute that single logic between multiple physical logics.

Furthermore, the logic(s) presented herein for accomplishing various methods of this system may be directed towards improvements in existing computer-centric or internet-centric technology that may not have previous analog versions. The logic(s) may provide specific functionality directly related to structure that addresses and resolves some problems identified herein. The logic(s) may also provide significantly more advantages to solve these problems by providing an exemplary inventive concept as specific logic structure and concordant functionality of the method and system. Furthermore, the logic(s) may also provide specific computer implemented rules that improve on existing technological processes. The logic(s) provided herein extends beyond merely gathering data, analyzing the information, and displaying the results. Further, portions or all of the present disclosure may rely on underlying equations that are derived from the specific arrangement of the equipment or components as recited herein. Thus, portions of the present disclosure as it relates to the specific arrangement of the components are not directed to abstract ideas. Furthermore, the present disclosure and the appended claims present teachings that involve more than performance of well-understood, routine, and conventional activities previously known to the industry. In some of the method or process of the present disclosure, which may incorporate some aspects of natural phenomenon, the process or method steps are additional features that are new and useful.

The articles “a” and “an,” as used herein in the specification and in the claims, unless clearly indicated to the contrary, should be understood to mean “at least one.” The phrase “and/or,” as used herein in the specification and in the claims (if at all), should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc. As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e. “one or the other but not both”) when preceded by terms of exclusivity, such as “either,” “one of,” “only one of,” or “exactly one of.” “Consisting essentially of,” when used in the claims, shall have its ordinary meaning as used in the field of patent law.

As used herein in the specification and in the claims, the phrase “at least one,” in reference to a list of one or more elements, should be understood to mean at least one element selected from any one or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a non-limiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

When a feature or element is herein referred to as being “on” another feature or element, it can be directly on the other feature or element or intervening features and/or elements may also be present. In contrast, when a feature or element is referred to as being “directly on” another feature or element, there are no intervening features or elements present. It will also be understood that, when a feature or element is referred to as being “connected”, “attached” or “coupled” to another feature or element, it can be directly connected, attached or coupled to the other feature or element or intervening features or elements may be present. In contrast, when a feature or element is referred to as being “directly connected”, “directly attached” or “directly coupled” to another feature or element, there are no intervening features or elements present. Although described or shown with respect to one embodiment, the features and elements so described or shown can apply to other embodiments. It will also be appreciated by those of skill in the art that references to a structure or feature that is disposed “adjacent” another feature may have portions that overlap or underlie the adjacent feature.

Spatially relative terms, such as “under”, “below”, “lower”, “over”, “upper”, “above”, “behind”, “in front of”, and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if a device in the figures is inverted, elements described as “under” or “beneath” other elements or features would then be oriented “over” the other elements or features. Thus, the exemplary term “under” can encompass both an orientation of over and under. The device may be otherwise oriented (rotated 90 degrees or at other orientations) and the spatially relative descriptors used herein interpreted accordingly. Similarly, the terms “upwardly”, “downwardly”, “vertical”, “horizontal”, “lateral”, “transverse”, “longitudinal”, and the like are used herein for the purpose of explanation only unless specifically indicated otherwise.

Although the terms “first” and “second” may be used herein to describe various features/elements, these features/elements should not be limited by these terms, unless the context indicates otherwise. These terms may be used to distinguish one feature/element from another feature/element. Thus, a first feature/element discussed herein could be termed a second feature/element, and similarly, a second feature/element discussed herein could be termed a first feature/element without departing from the teachings of the present invention.

An embodiment is an implementation or example of the present disclosure. Reference in the specification to “an embodiment,” “one embodiment,” “some embodiments,” “one particular embodiment,” or “other embodiments,” or the like, means that a particular feature, structure, or characteristic described in connection with the embodiments is included in at least some embodiments, but not necessarily all embodiments, of the invention. The various appearances “an embodiment,” “one embodiment,” “some embodiments,” “one particular embodiment,” or “other embodiments,” or the like, are not necessarily all referring to the same embodiments.

If this specification states a component, feature, structure, or characteristic “may”, “might”, or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

As used herein in the specification and claims, including as used in the examples and unless otherwise expressly specified, all numbers may be read as if prefaced by the word “about” or “approximately,” even if the term does not expressly appear. The phrase “about” or “approximately” may be used when describing magnitude and/or position to indicate that the value and/or position described is within a reasonable expected range of values and/or positions. For example, a numeric value may have a value that is +/−0.1% of the stated value (or range of values), +/−1% of the stated value (or range of values), +/−2% of the stated value (or range of values), +/−5% of the stated value (or range of values), +/−10% of the stated value (or range of values), etc. Any numerical range recited herein is intended to include all sub-ranges subsumed therein.

Additionally, any method of performing the present disclosure may occur in a sequence different than those described herein. Accordingly, no sequence of the method should be read as a limitation unless explicitly stated. It is recognizable that performing some of the steps of the method in a different order could achieve a similar result.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of various embodiments of the disclosure are examples and the disclosure is not limited to the exact details shown or described.

What is claimed:

1. A battery pack comprising:
a first plurality of individual battery cells arranged into a first battery stack having a first voltage rating in operative communication with a first output, the first output having the same voltage rating as the first battery stack; a second plurality of individual battery cells arranged to a second battery stack having a second voltage rating in operative communication with a second output, the second output having the same voltage rating as the second battery stack; and a third plurality of individual battery cells arranged into a third battery stack having a third voltage rating in operative communication with a third output, the third output having the same voltage rating as the third battery stack;
a battery management system wherein the battery management system is able to recognize or be programmed to recognize battery type of the battery cells within each of the first battery stack, the second battery stack and the third battery stack; and
a charger in operative communication with, and operable to recharge, each of the first, second, and third battery stacks.

2. The battery pack of claim 1, wherein the first plurality of individual battery cells, the second plurality of individual battery cells and the third plurality of individual battery cells comprise at least one of the following types of battery cells: NiCd, NiMH, Lead Acid, LCO, LMO, NMC, LFP, NCA and LTO.

3. The battery pack of claim 2, wherein the first battery stack is rated to deliver 24 volts through the first output.

4. The battery pack of claim 3 wherein the first and second battery stacks are rated to deliver 36 volts through the second output.

5. The battery pack of claim 4 wherein the first, second, and third battery stacks are rated to deliver 48 volts through the third output.

6. The battery pack of claim 2 wherein the battery management system further comprises:
a charging system operable to direct the charger to recharge the first, second, and third battery stacks.

7. The battery pack of claim 2 further comprising:
a communications port in operable communication with the battery management system and further operable to communicate battery data to an external device and battery data to the battery management system.

8. The battery pack of claim 7 wherein the communications port further comprises:
a wireless transceiver operable to wirelessly transmit battery data to the external device.

9. The battery pack of claim 2 further comprising:
a display unit operable to display at least one of the capacity, charge level, ambient temperature, operating time, battery type and voltage of the battery pack.

10. A method of discharging a battery pack comprising:
receiving a connection to an apparatus in one of a first output, a second output, and a third output of a battery pack;
providing a first battery stack, a second battery stack and a third battery stack;
adjusting the battery pack in response to at least one identifying indicia on the battery stack corresponding to a battery type; and
discharging power from at least one of: the first battery stack in response to receiving the connection in the first output; the first battery stack and the second battery stack in response to receiving the connection in the second output; and the first battery stack, the second battery stack, and the third battery stack in response to receiving the connection in the third output.

11. The battery pack of claim 10, wherein the first battery stack, the second battery stack, and the third battery stack comprise battery cells of at least one of the following types of battery cells: NiCd, NiMH, Lead Acid, LCO, LMO, NMC, LFP, NCA and LTO.

12. The method of claim 11 wherein the first battery stack is rated at 24 volts and the method further comprises:
discharging 24 volts of power from the first battery stack through the first output in response to receiving the connection in the first output.

13. The method of claim 12 wherein the second battery stack is rated at 12 volts and the method further comprises:
discharging 36 volts of power from the first battery stack and the second battery stack through the second output in response to receiving the connection in the second output.

14. The method of claim 13 wherein the third battery stack is rated at 12 volts and the method further comprises:
discharging 48 volts of power from the first battery stack, the second battery stack, and the third battery stack through the third output in response to receiving the connection in the third output.

15. The method of claim 11 wherein the battery pack includes a battery management system and the method further comprises:
monitoring the charge level of the first battery stack, the second battery stack, and the third battery stack via the battery management system; and
interrupting the discharge of the first battery stack, the second battery stack, and the third battery stack via the battery management system when the charge level falls below a preset threshold.

16. A method of charging a battery pack comprising:
receiving a connection to an external power source by a plug on a battery pack;
providing a first battery stack, a second battery stack and a third battery stack;
adjusting the battery pack in response to at least one identifying indicia on the battery stack corresponding to a battery type; and
delivering power through a charger carried in the battery pack to one or more of the first battery stack, the second battery stack, and the third battery stack, according to the relative power levels thereof such that power is first delivered to the battery stack with the lowest charge level before delivering power to battery stacks with higher charge levels and wherein the first battery stack, second battery stack and third battery stack have the same battery cell types.

17. The battery pack of claim 16, wherein the first battery stack, the second battery stack, and the third battery stack comprise battery cells of at least one of the following types of battery cells: NiCd, NiMH, Lead Acid, LCO, LMO, NMC, LFP, NCA and LTO.

18. The method of claim 17 further comprising:
delivering power to the battery stack with the lowest relative charge level to raise the battery stack to a charge level equal to a charge level of the battery stack with the second highest charge level;
delivering power to the both of the equal battery stacks simultaneously to raise the charge levels thereof to a charge level equal to the charge level of the battery stack with the highest charge level; and
delivering power to all three of the first, second, and third battery stacks simultaneously to raise the charge levels thereof to a full capacity charge level.

19. The method of claim 17 wherein the battery pack includes a battery management system and the method further comprises:
monitoring the charge level of the first battery stack, the second battery stack, and the third battery stack via the battery management system;
directing the delivery of power between the first, second, and third battery stacks according to the relative charge levels thereof; and
interrupting the delivery of power to the first, second, and third battery stacks when the charge levels thereof reach the full capacity charge level.

20. The method of claim 17 further comprising:
directing the delivery of power to all three of the first, second, and third battery stacks regardless of their relative charge levels only when the battery management system determines that the charge levels of are three battery stacks are below a minimum threshold;
charging each of the first, second, and third battery stacks nearly simultaneously to the full capacity charge level; and
interrupting the delivery of power to the first, second, and third battery stacks individually when the charge levels of each stack reaches the full capacity charge level.
